(19) United States
(12) Patent Application Publication
(10) Pub. No.: US 2006/0110283 A1
(43) Pub. Date: May 25, 2006

(54) Photometric determination of coagulation time in undiluted whole blood

(75) Inventor: Falk Fish, Tel Aviv (IL)

Correspondence Address: FOLEY HOAG, LLP;PATENT GROUP, WORLD TRADE CENTER WEST, 155 SEAPORT BLVD, BOSTON, MA, 02110, US

(73) Assignee: Inverness Medical Switzerland GmbH, Zug (CH)

(21) Appl. No.: 10/516,053

(22) PCT Filed: Nov. 12, 2003
(86) PCT No.: PCT/IL03/00958

§ 371 Date: Nov. 29, 2004

Related U.S. Application Data
(60) Provisional application No. 60/425,300, filed on Nov. 12, 2002.

(51) Int. Cl. G01N 21/64

(52) U.S. Cl. 422/52; 422/82.08

(57) ABSTRACT

A device, system and method for photometric detection of coagulation in whole blood. The present invention is easy to implement and operate. Furthermore, the present invention has the advantage of being considered to fulfill the desired standard of using photometry for measuring blood coagulation. Also, a photometric coagulation test device for whole blood specimens according to the present invention provides medical accuracy to the home user and, at the same time, is simple to construct. The present invention is also useful for detecting and determining blood agglutination, for example as the results of a serological reaction with an antibody.

### FIELD OF THE INVENTION

The present invention is of a system, device and method for detecting coagulation of a free-flowing liquid, such as blood.

### BACKGROUND OF THE INVENTION

Anticoagulant therapy is prescribed to an increasing number of patients with a variety of cardiovascular conditions, such as venous or arterial thrombosis, embolism and cardiac valve replacement. Since the anticoagulant drug activity and efficacy is affected by the patient's lifestyle and diet, frequent monitoring of the coagulation status of the blood is required, to maintain a suitable dosage level within the therapeutic window for such drugs. For the patient, this requirement results in at least weekly travel to a clinic with painful drawing of a venous blood specimen.

The classical and standard reference blood coagulation tests involve the measurement of the time required to form a clot. Clot formation is determined by two general approaches: (a) detecting a change in the mechanical (e.g. physical) properties of the blood specimen, assuming that the clot behaves differently from the liquid in the test; or (b) measuring the optical properties of the specimen, again assuming that the clot affects the passage, reflectance or scattering of light by the blood to at least some degree, and that the test can detect such a change accurately and efficiently.

The most basic and oldest mechanical method involves continuous tilting of the blood containing tube with visual monitoring to visually detect the formation of a clot. A popular automation of the mechanical approach is based on the immersion of magnetic particles, balls or rods in the specimen, which are then moved by an externally applied rotating magnetic force. The movement of the magnetic items is followed by electro-optical means. Clot formation is detected by the interference of the clot with the movement of the magnetic parts. Other mechanical approaches, such as viscosity determination and resistance to movement, were published but enjoyed only limited commercial success.

Photometry is the other approach for detecting blood coagulation. Photometry may be described as the measurement of light reflected, transmitted or scattered from and/or through a medium or object without inducing any physical movement on or in the medium or object or imposing any mechanical or physical force on the object or medium.

The optical-photometric approach is the simplest to automate, since no mechanical manipulation of the specimen is required. However, it is currently understood by professionals in this area that optical analysis of the blood requires removal of the blood cells prior to analysis in order to provide an unimpeded view of the clot. Therefore, the current practice and knowledge in the field is that optical methods can only be performed on separated blood plasma and not on whole blood (NCCLS H21-A3: Collection, Transport, and Processing of Blood Specimens for Coagulation Testing and General Performance of Coagulation Assays; Approved Guideline—Third Edition, National Committee for Clinical Laboratory Standards; see: http://www.nccls.org/). The optical methods for determination of clot formation are applied in two general variations: (a) transmission photometry, and (b) reflectance-scattering photometry.

In light transmission methods, the amount of light that is passing through the separated plasma is measured. In such methods the light is usually irradiated perpendicularly to the surface of the container, containing the blood, and the transmitted light is detected perpendicularly to the surface on the other side of the container. Formation of the clot is associated with a reduction in the amount of transmitted light.

In the reflectance-scattering methods, light which bounces back from the specimen (reflected light) is at a different angle than the angle of the incident light; the amount of this reflected light is measured. Typically but optionally, the incident light is transmitted at a non-perpendicular angle and the reflected-scattered light is measured perpendicularly to the surface of the container containing the blood. The formation of a blood clot is accompanied by an increase in the amount of reflected-scattered light. Nephelometries in general and laser nephelometry in particular are variations of reflectance photometry, and may result in improved sensitivity and specificity. The term “Scattering” generally means deviation of light from the expected straight path. Scattering can be determined by both transmission photometry and by reflectance photometry, as described above, depending on the optical and mechanical design of the measuring instrument or meter.

Optical-photometric methods drive some of the most popular laboratory coagulation meters and provide the current reference standard for coagulation metering. All newly developed technologies are compared to them. While the photometric determination of clot formation is relatively simple, it requires the removal of the blood cells from the blood specimen prior to testing. In addition, the plasma specimen is diluted to a ratio of 1:1 or 1:2 with the coagulation reagent, which further assists photometric analysis. Because of this specimen preparation step (i.e. collection and preservation of blood, followed by separation of plasma), photometric coagulation tests can be performed only in a properly equipped laboratory.

Following the general trend in healthcare to transfer more medical procedures to the patient's home, such as with regard to blood glucose monitoring which is performed regularly by diabetics in the home environment, methods and devices for the non-laboratory determination of coagulation time were recently developed and commercialized. Prothrombin Time (PT) and Activated Partial Thromboplastin Time (APTT) tests are the most prevalent tests available in a non-laboratory, or home, format. These methods rely on a relatively small specimen of capillary blood (obtained by a finger prick). Due to the small size of the specimen and inability of the patient to separate the cells from the plasma, the home methods do not employ the reference and simple optical photometric approach for clot detection. Instead, various surrogate markers for clot formation were sought, not all of which met with analytical and/or commercial success.

The patent literature provides a number of proposed methods, claiming correlation with various electrical properties of the specimen: resistance, impedance, capacitance and their variations. Electrical measurements are the simplest technology to apply, even simpler than photometric ones, however, none succeeded to get to the market, probably due to technological failure to actually deliver the expected test results. A recent electrochemical variation of the electrical approach, developed by Hemosense, Inc (for example U.S. Pat. Nos. 6,046,051 and 6,060,323) succeeded in overcoming the problems of electrical measurement and getting to the market. Roche (formerly: Boehringer; Basel, Switzerland) provides mechanical detection of clot formation in portable instruments. One instrument is based on following the movement of magnetic particles immersed in the blood specimen. The other instrument monitors the movement of blood through a transparent capillary channel by observing the passage of red blood cells through it. ITC (International Technidyne Corp, Edison, N.J., USA) presented a mechanical coagulation meter based on determining the resistance of the clotted blood to movement through a capillary under air pressure. The instruments or meters of the last two companies are quite large, heavy and expensive. A completely different approach for coagulation time determination was presented by Avocet Medical, Inc., CA, USA. They developed a chemical reaction based test, in which the enzymatic activity of thrombin is detected by a fluorogenic substrate (U.S. Pat. No. 5,418,141).

One of the drawbacks of these non-photometric methods is the need to demonstrate their equivalence to photometric methods to regulatory authorities. Such equivalence does not always exist.

### SUMMARY OF THE PRESENT INVENTION

The background art does not teach or suggest a device, system or method for detecting coagulation of whole blood by using photometry. The background art also does not teach or suggest such a device, system and method which is simple and easy to use. The background art also does not teach or suggest such a photometric device, system and method which are capable of detecting coagulation of a free-flowing liquid.

The present invention overcomes these drawbacks of the background art by providing a device, system and method for photometric detection of coagulation in whole blood. The present invention is easy to implement and operate. Furthermore, the present invention has the advantage of being considered to fulfill the desired standard of using photometry for measuring blood coagulation. Also, a photometric coagulation test device for whole blood specimens according to the present invention provides medical accuracy to the home user and, at the same time, is simple to construct. The present invention can more easily obtain regulatory approval/clearance because of its adherence to the photometric technology. The present invention is also useful for testing cessation of movement in a free flowing liquid other than blood, for example due to other types of coagulation.

The present invention provides the unexpected result that blood coagulation and/or clot formation can be detected in whole, undiluted blood specimens employing an easily implemented and operated photometric device. Both transmittance and reflectance modes of photometry may optionally be used.

Photometric determination of coagulation may be described as the detection of the blood coagulation event by photometry. Such photometric detection preferably does not include monitoring of the movement of blood, or the movement of any particles or other objects which were added to the blood for the purpose of coagulation detection.

In one optional embodiment of the invention, photometry may optionally be performed inside a disposable, test-strip-like hollow device, which contains the coagulation reagents in a dry, ready-for-use form. The size of the strip can be reduced, so that the amount of blood required is sufficiently small (microliters or fractions thereof) to reduce discomfort and pain to the patient. The strip may then optionally be inserted into a small, portable meter, which may optionally and preferably include a low cost, low power light source and a basic light sensor. Alternatively, the light source and light sensitive devices may optionally be incorporated in their chip form into the disposable test strip, thus further improving the user interface and increasing the ease of operation. The time required for the determination of coagulation time may optionally be shortened by employing novel signal analysis strategies.

According to yet another embodiment of the present invention, there is provided a method for the determination of coagulation time of a blood sample, wherein the method is performed in a time interval, the time interval being shorter than the coagulation time of the sample. Other optional but preferred embodiments of the present invention are as follows. According to the present invention, there is provided a photometric method for the determination of coagulation in whole, undiluted blood. Optionally, this method is used for the determination of coagulation time.

According to still another embodiment of the present invention, there is provided a device for the photometric determination of coagulation in a sample of undiluted whole blood, comprising: (a) a test strip for receiving the sample of undiluted whole blood; (b) a light emission source for emitting light, such that the light is projected onto the test strip; and (c) a light detector for measuring an amount of light from the test strip, such that the amount of light is affected by a coagulation state of the undiluted whole blood, wherein the coagulation is determined according to the amount of light.

Preferably, the test strip comprises a reaction chamber for receiving the sample of undiluted whole blood, and wherein a depth of the sample of undiluted whole blood in the reaction chamber is less than about 10 mm.

More preferably, the depth is less than about 1 mm.

Most preferably, the depth is less than about 0.1 mm.

Optionally, the light detector measures at least one of reflectance-scattering of light from the sample, transmission of light through the sample, transmittance-scattering of light through the sample, or absorption of light by the sample. Preferably, the light detector measures at least one of transmission of light through the sample, transmittance-scattering of light through the sample, or absorption of light by the sample, and wherein at least one wall of the reaction chamber is at least partially transparent, such that the light detector is located on an opposing side of the at least one wall from the sample.

Optionally and preferably, the sample of blood enters the reaction chamber according to a force. More preferably, the force includes at least one of capillary, gravitational, vacuum, pressure, electric, endosmotic, osmotic, hydrophobic, hydrophilic or centrifugal force, or a combination thereof. Most preferably, the force comprises at least one of gravitation and capillary force.

According to preferred embodiments of the present invention, the device further includes a housing, wherein the light emission source and the light detector are contained within the housing, and the test strip is inserted into the housing.

Alternatively, the device further includes a housing and at least one light guide, wherein the light emission source and the light detector are contained within the housing, and at least a first portion of the at least one light guide is contained within the housing, while at least a second portion of the at least one light guide protrudes from the housing, such that light from the light emission source is transmitted to the test strip through the at least one light guide, while light from the test strip is brought to the light detector through the at least one light guide.

Also alternatively, the device further includes a housing and at least one light guide, wherein the light emission source and the light detector are contained within the housing, and at least a first portion of the at least one light guide is contained within the housing, while at least a second portion of the at least one light guide is located within the test strip, such that light from the light emission source is transmitted to the test strip through the at least one light guide, while light from the test strip is brought to the light detector through the at least one light guide.

According to still other preferred embodiments of the present invention, the light detector and the light emission source are mounted on the test strip.

Preferably, the coagulation state is determined according to a rate of coagulation of the sample. More preferably, the rate of coagulation is determined according to at least one of deflection points, ratios and rate ratios.

Optionally, the coagulation state is determined according to coagulation time.

Preferably, the light emission source comprises at least one of a lamp (incandescent, neon, etc) or a solid state light emitting device/chip. More preferably, the solid state light emitting device/chip is selected from the group consisting of a LED (Light Emitting Diode), LASER and an electroluminescent device.

Preferably, the light detector includes at least one of a photodiode, phototransistor, photocell, Darlington phototransistors, or a photomulitiplier. More preferably, the light detector comprises a photodiode.

Preferably, the device is operable for determining coagulation at an ambient temperature. Also preferably, the device includes a temperature measurement component.

According to a preferred embodiment of the present invention, the device is provided as a kit. More preferably, the kit is designed for use by any one or more of non medically trained personnel, a patient, a non-profession or lay person, or any person in a home or field environment. Optionally and more preferably, the kit is portable.

According to another embodiment of the present invention, there is provided a method for photometrically measuring coagulation in a sample of undiluted whole blood, comprising: providing a device for measuring coagulation of the sample, wherein the device comprises a test strip having a reaction chamber for receiving the sample for the measuring, wherein a light path through the sample in the reaction chamber is less than about 10 mm; and measuring at least one of coagulation rate and coagulation time of the sample.

Preferably, the coagulation rate is measured for determining coagulation time in the sample, wherein a period of time for measuring the coagulation rate is less than about the coagulation time.

According to another optional embodiment of the present invention, there is provided a system for photometrically measuring coagulation in a sample of undiluted whole blood, comprising: (a) a device as described above; and (b) at least one output device for providing a result from a measurement by the device to a user. The output device may optionally be selected from the group consisting of a printing device, a display device and a transmission device for transmission to a remote location.

According to another optional but preferred embodiment of the present invention, it may also be employed for the determination of agglutination in blood. For the purpose of the present invention, the term “agglutination” preferably includes a reaction or process in which particles or cells (e.g. erythrocytes) collect into clumps, for example as a serological response to a specific antibody. Blood agglutination may therefore preferably include the agglutination of blood cells, especially erythrocytes. Blood agglutination may be caused by antibodies directed against the cells. Hereinafter, unless otherwise indicated, the term “coagulation” also includes blood agglutination, at least with regard to the operation of the device, system and method according to the present invention.

According to the present invention, there is provided a device for the photometric determination of coagulation in a sample of undiluted whole blood, comprising: (a) a test strip for receiving the sample of undiluted whole blood; (b) a light emission source for emitting light, such that the light is projected onto the test strip; and (c) a light detector for measuring an amount of light from the test strip, such that the amount of light is affected by a coagulation state of the undiluted whole blood, wherein the coagulation is determined according to the amount of light. Preferably, the test strip comprises a reaction chamber for receiving the sample of undiluted whole blood, and wherein a depth of the sample of undiluted whole blood in the reaction chamber is less than about 1 mm. More preferably, the depth is less than about 1 mm. Most preferably, the depth is less than about 0.1 mm.

Optionally and preferably, the light detector measures at least one of reflectance-scattering of light from the sample, transmission of light through the sample, transmittance-scattering of light through the sample, or absorption of light by the sample. More preferably, the light detector measures at least one of transmission of light through the sample, transmittance-scattering of light through the sample, or absorption of light by the sample, and wherein at least one wall of the reaction chamber is at least partially transparent, such that the light detector is located on an opposing side of the at least one wall from the sample.

Optionally, the sample of blood enters the reaction chamber according to a force. Preferably, the force includes at least one of capillary, gravitational, vacuum, pressure, electric, endosmotic, osmotic, hydrophobic, hydrophilic or centrifugal force, or a combination thereof. More preferably, the force comprises at least one of gravitation and capillary force.

Optionally and preferably, the device further comprises a housing, wherein the light emission source and the light detector are contained within the housing, and the test strip is inserted into the housing.

Alternatively, the device further comprises a housing and at least one light guide, wherein the light emission source and the light detector are contained within the housing, and at least a first portion of the at least one light guide is contained within the housing, while at least a second portion of the at least one light guide protrudes from the housing, such that light from the light emission source is transmitted to the test strip through the at least one light guide, while light from the test strip is brought to the light detector through the at least one light guide.

Also alternatively, the device further comprises a housing and at least one light guide, wherein the light emission source and the light detector are contained within the housing, and at least a first portion of the at least one light guide is contained within the housing, while at least a second portion of the at least one light guide is located within the test strip, such that light from the light emission source is transmitted to the test strip through the at least one light guide, while light from the test strip is brought to the light detector through the at least one light guide.

Optionally and preferably, the light detector and the light emission source are mounted on the test strip.

Also preferably, the coagulation state is determined according to a rate of coagulation of the sample. More preferably, the rate of coagulation is determined according to at least one of deflection points, ratios and rate ratios.

Preferably, the coagulation state is detected according to a time period for the amount of light to reach a predetermined value.

Also preferably, the coagulation state is detected according to a ratio of change of a plurality of light measurements taken after the test strip receives the sample of undiluted whole blood, the ratio of change being proportional to the coagulation time of the sample. More preferably, the test strip comprises a reaction chamber and wherein the ratio of change is determined at least partially according to an initial light measurement when the blood enters the reaction chamber. Also more preferably, the ratio of change is determined at least partially according to an initial light measurement determined according to a triggering algorithm. Most preferably, the triggering algorithm operates to detect a change in an amount of light over a predetermined threshold. Also most preferably, the change is determined after blood is applied to the test strip.

Optionally and preferably, the coagulation state is detected according to a quantitative determination of coagulation time. More preferably, the quantitative determination is performed according to at least one of a value or a magnitude of an amount of light. Also more preferably, the quantitative determination is relative to a reference value. Most preferably, the reference value comprises at least one of a control reaction chamber for receiving a portion of the sample or an initial light measurement with the sample substantially before a coagulation process is initiated.

Optionally, wherein the light emission source comprises at least one of a lamp (incandescent, neon, etc) or a solid state light emitting device/chip. Preferably, the solid state light emitting device/chip is selected from the group consisting of a LED (Light Emitting Diode), LASER and an electroluminescent device.

Optionally and preferably, the light detector includes at least one of a photodiode, phototransistor, photocell, Darlington phototransistors, or a photomultiplier. More preferably, the light detector comprises a photodiode.

Preferably, the device is operable for determining coagulation at an ambient temperature. Also preferably, the device comprises a temperature measurement component.

According to another optional but preferred embodiment of the present invention, the device according to the present invention, having any or a combination of the characteristics as described herein, is provided as a kit. Preferably, the kit is designed for use by any one or more of non medically trained personnel, a patient, a non-profession or lay person, or any person in a home or field environment. Also preferably, the kit is portable.

Preferably, at least agglutination is measured with the kit or device.

Optionally and preferably, the device features a dark optical background.

According to another embodiment of the present invention, there is provided a method for photometrically measuring coagulation in a sample of undiluted whole blood, comprising: providing a device for measuring coagulation of the sample, wherein the device comprises a test strip having a reaction chamber for receiving the sample for the measuring, wherein a light path with regard to the sample in the reaction chamber is less than about 10 mm; at least one of transmitting light through and reflecting light from the sample; and measuring at least one of coagulation rate and coagulation time of the sample according to at least one of transmitted or reflected light.

Preferably, coagulation rate is measured for determining coagulation time in the sample, wherein a period of time for measuring the coagulation rate is less than about the coagulation time.

Optionally, at least agglutination is measured.

Preferably, the device used for the method has any or a combination of the characteristics of the device as described herein.

According to yet another embodiment of the present invention, there is provided a photometric method for the determination of coagulation in whole, undiluted blood. Preferably, the method is used for the determination of coagulation time.

According to still another embodiment of the present invention, there is provided a photometric method for the determination of agglutination in whole, undiluted blood.

According to another embodiment of the present invention, there is provided a method for the determination of coagulation time of a blood sample, wherein the method is performed in a time interval, the time interval being shorter than the coagulation time of the sample.

According to yet another embodiment of the present invention, there is provided a system for photometrically measuring coagulation in a sample of undiluted whole blood, comprising: (a) a device as described herein; and (b) at least one output device for providing a result from a measurement by the device to a user. Optionally and preferably, the output device is selected from the group consisting of a printing device, a display device and a transmission device for transmission to a remote location.

In the present specification, a number of terms are discussed hereinunder, for the purposes of description only and without any intention of being limiting.

The term “undiluted blood” refers to a blood specimen which was not diluted, either before or during the test, by the addition of a non-whole blood liquid, including such liquids as the reagents of coagulation tests, which may result in a 2- or 3-fold dilution of the blood. However, it should be noted that the addition of a fractional volume (about 10%) of whole blood preservation or anticoagulation liquid is preferably not considered to be dilution according to the present invention. Thus, whole blood, preserved with citrate, which results in an about 10% dilution or fractional dilution is optionally and preferably considered to be undiluted blood for the purpose of the present invention.

Hereinafter, the terms “clotting” and “coagulation” are used interchangeably unless otherwise stated.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows different exemplary shapes for the chamber with conduit in a test-strip according to the present invention: 1A: A round chamber and a short conduit; 1B: A traverse rectangular chamber with 2 conduits; and 1C: A longitudinal reaction chamber without a specific conduit part (i.e. an end part of the chamber can serve as a conduit);

FIG. 2 shows different optional exemplary arrangements of reaction chambers and conduits in a multiple-chamber test strip; the arrows indicate the entry point of the specimen;

FIG. 3 shows an illustrative schematic block diagram of a transmission photometry according to the present invention;

FIG. 4 shows an illustrative schematic block diagram of reflectance-scattering photometry according to the present invention;

FIGS. 5A-B show reflectance-scattering of light from blood in three different kinds of test-strips according to the present invention;

FIGS. 6A-B show the effect of the color of light on the differentiation between coagulated and non-coagulated blood specimens in transmission of light through blood in three kinds of test-strips according to the present invention;

FIGS. 7A-B show the determination of coagulation time by transmittance according to the present invention, and

FIGS. 8A-C show the determination of coagulation time by Reflectance-Scattering according to the present invention.

### DETAILED DESCRIPTION OF THE PREFERRED EMBODIMENTS

The present invention is of a device, system and method for photometric detection of coagulation in whole blood. The present invention is easy to implement and operate. Furthermore, the present invention has the advantage of being considered to fulfill the desired standard of using photometry for measuring blood coagulation. Also, a photometric coagulation test device for whole blood specimens according to the present invention provides medical accuracy to the home user and, at the same time, is simple to construct. The present invention is also useful for detecting and determining blood agglutination, for example as the results of a serological reaction with an antibody.

Photometry of the coagulation reaction can be realized by reflectance-scattering of light from the blood specimen (or sample; it is noted that these terms may be used interchangeably for the present invention), transmission of light through the specimen, transmittance-scattering of light through the specimen or absorption of light by the specimen. The photometric difference between a coagulated specimen and an uncoagulated specimen, such as whole, undiluted blood for example, may optionally be enhanced according to preferred embodiments of the present invention by employing particular implementations of the specimen container, light source, optical background, and sensor spatial arrangements. Hereinafter, the term “container” refers to any device or container for receiving the specimen, also preferably including a strip or test strip as described in greater detail below.

The present invention may optionally and preferably be employed with very small volumes of blood (microliter range), so that it can form the basis for home coagulation monitoring system for the benefit of patients on anti-coagulant therapy. The present invention, therefore, can serve to determine the time required for blood coagulation and may optionally be implemented for any medical test which is based on coagulation timing, including but not limited to Prothrombin Time (PT) and Activated Partial Thromboplastin Time (APTT) tests. The present invention may also optionally be used for any type of blood agglutination test.

According to an optional but preferred embodiment of the present invention, the device optionally and preferably features a container for receiving the blood specimen. The container preferably features a chamber, optionally with at least one inlet for specimen entry. The chamber may optionally be implemented as any hollow structure and/or cavity and/or vessel. The chamber preferably contains the reagent(s) required for determining the coagulation time, more preferably in a dry form. By “contains”, it is also meant that the chamber may be covered with the reagent(s). If a reaction occurs in the chamber, such as coagulation for example, it may optionally be termed a reaction chamber. The container may optionally be implemented as a “test strip” or “strip” and is preferably intended for single use (i.e. is disposable). The test strip or strip of the present invention may optionally assume any shape or geometry.

The specimen, such as blood for example, is introduced to or applied to the preferred embodiment of a test strip as the container. The test strip receives the specimen, for example by enabling the specimen to optionally cover the strip, and/or alternatively enter the hollow structures of the strip through an optional inlet. In any case, the specimen preferably mixes with the dried reagent(s) if present. The hollow structure may optionally have an outlet to facilitate improved entry of the specimen by the expulsion of air from the hollow structure, by avoiding trapping air. If there is no outlet to permit expulsion of such air, the trapped air may slow or completely negate entry of the liquid specimen or sample. The outlet may optionally be implemented in various shapes and sizes. Small outlet apertures (e.g micron range diameter) can by themselve permit air (gas) passage and stop the passage of water based solutions, such as blood, because of their size and relative geometry. Alternatively, the outlet may optionally be covered with a hydrophobic porous membrane, mesh or woven or non-woven fabrics. Both inlet and outlet may optionally be located at different locations on the container and may optionally face various directions relative to the orientation of the container itself, such as sideways, upward or downward for example.

Optionally and preferably, the container features a conduit, which is a structure for transporting a liquid, such as a blood specimen for example, between the outside of the container and a chamber, or optionally between chambers. Conduits may also optionally be implemented for transporting a gas or enabling the creation of a vacuum. The conduit may optionally be hollow.

Also optionally and preferably, at least a portion of the walls of the container (or a reaction chamber of the container), but more preferably the entirety of the walls, is at least partially transparent or translucent for enabling the photometric measurement of coagulation and/or agglutination of the specimen. For this optional embodiment, the light detector or sensor is preferably located on an opposing side of such a wall from the specimen (sample).

The container is preferably in communication with a meter (although not necessarily in physical contact), for performing the photometric measurement. The meter is a non-limiting example of a light sensor or detector. The coagulation of blood which occurs within the container can be easily monitored by light transmission or reflectance-scattering or transmittance scattering or absorption for the photometric measurement. The meter includes an instrument for measuring the light which is transmitted and/or reflected and/or scattered by or from the container. The meter may also optionally and preferably be capable of calculating some parameters from the measurement of the light. With regard to the illustrative non-limiting example of blood, the meter is preferably able to calculate the coagulation time based on the light measurement(s). The meter may also optionally and preferably include a light source, a light measurement circuit, processing circuit and display. Meters designed for home use are preferably portable, i.e. relatively small and light and optionally powered by a battery. The meter may also optionally include connections for outside devices, such as a printer or telephone. The meter is preferably intended for multiple uses, but may optionally also be disposable.

The operation of the meter for measuring light is optionally and preferably assisted by a light-guide, which is a structure designed to transport light between two or more points with minimal loss and preferably without being affected by ambient light outside the structure. Light guides operate on the principle of total internal reflection.

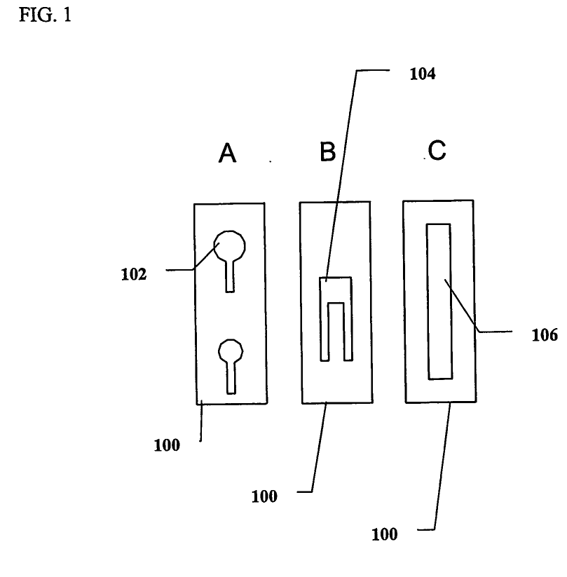

According to optional but preferred embodiments of the present invention, the container may optionally assume various shapes, including but not limited to a test tube or a flat test strip. The shape of the chamber within the container may optionally conform to the shape of the entire container, for example for a test-tube like container, or alternatively may optionally be different, for example for a test strip. For a test strip, for example, the chamber may optionally conform to the shape of the strip, for example rectangular, round or bent (see FIG. 1 for different exemplary shapes for a chamber in a test-strip). The cross sectional shape and/or profile of the chamber can be rectangular, round or of any other shape, including combinations thereof depending on the optical design requirements of the system.

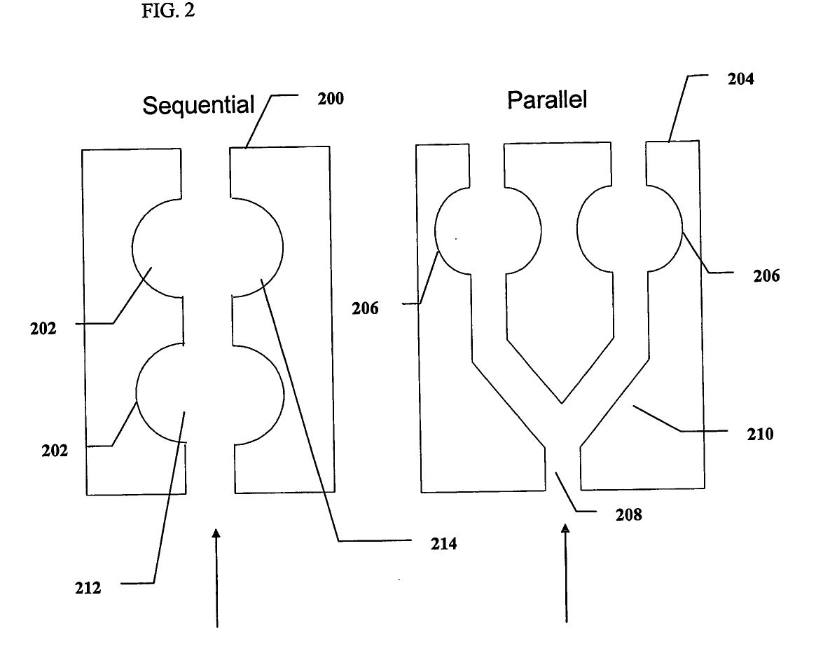

In another embodiment of the device, the container may optionally have more than one chamber. Additional chamber(s) may optionally serve as control reaction chambers for example. For example, if the coagulation reaction chamber contains dried coagulation reagent(s), a control chamber may optionally not contain any reagent at all, or may contain non-reactive ingredients, including but not limited to salts or surfactants for example. Thus, the optical activity of the blood in the control and reaction chambers may optionally be compared in order to improve reliability of the test and compensate for optical behavior variations between different specimens (see FIG. 2).

The container preferably features the coagulation reagent (and/or other types of reagents) in a dry form. In manufacturing the complete container, the reagent solution can either be administered into and/or placed onto the completely assembled container and dried for a relatively long time, or may optionally be dispensed into a non-assembled or partially assembled (open) device and dried. The first manufacturing approach (drying of a completely assembled device) may be slower and may require higher drying temperature, however, it may also result in a potentially more even distribution of the dried reagent over the walls of the reaction chamber.

The blood or other specimen can enter the chamber of the container by employing various forces, including but not limited to capillary, gravitational, vacuum, pressure, electric, endosmotic, osmotic, hydrophobic, hydrophilic or centrifugal force, or a combination thereof, or others. Gravitation and capillary forces assisted entry are preferable as they are the simplest to implement.

As previously described, the present invention may optionally be implemented with transmission or reflection photometry. For transmission photometry at least two opposing walls of the reaction and control chambers are preferably capable of permitting light transmission (ie at least partially transparent or translucent), although not necessarily clear (ie completely transparent). The length of the light path, i.e. the thickness of the layer of blood or other specimen through which light absorption is measured, is optionally and preferably less than that of standard photometer cuvettes, i.e. optionally and preferably less than about 10 mm. Preferably, the light path should be less than about 1 mm in length, and more preferably less than about 0.25 mm in length. White light may optionally be employed for the light source, but specific colors (spectra) of light, such as green light for example, may afford improved sensitivity in the case of blood. Monochromatic light may afford improved specificity; however, the present invention may optionally be implemented without monochromatic light. In the determination of coagulation by transmission photometry of whole, undiluted blood, coagulated blood absorbs more light than non-coagulated blood.

Transmittance or transmission may be described as the amount of light that is transmitted through (or passes through) a medium (such as blood for example). Unless the medium is optically transparent, part of the light is absorbed. In an ideal situation, when the medium is optically clear, if the incident light is radiated perpendicularly to the surface of the medium, the transmitted fraction of the light emerges at the same angle.

However, more usually, transmission scattering occurs. If the incident light is radiated perpendicularly to the medium, the amount or fraction of the transmitted light which is directed randomly, i.e. directed to an angle which is different from the perpendicular, represents the transmission scattering. Transmission scattering usually occurs when the medium is turbid or contains light reflecting particles, as is the situation with whole blood for example.

For reflectance-scattering photometry at least one wall of the reaction and control cavities is optionally and preferably at least partially transparent. Reflectance or reflection is the light that is bounced or reflected from a surface upon which the light is incident. The amount of bounced light may vary according to the optical characteristics of the surface. If the surface is optically at least partially transparent or clear, then at least part of the reflected light is reflected by the material located behind that surface. In an ideal situation, the angle of incidence is equal to the angle of reflection. However, more usually, reflection-scattering or reflectance-scattering occurs, which is the amount or fraction of the reflected light that is directed randomly, i.e. directed to an angle which is different from the angle of incidence. Scattering may occur when the incident light is reflected from randomly orientated particles or structures in the medium (e.g. blood), each acting as a “mirror” reflecting light to a different direction.

When reflectance photometry is employed for coagulation monitoring, the thickness of the layer of blood and the color of the surface behind the blood or optical background, have a significant effect on the contrast between coagulated and non-coagulated blood. The optical background is the surface in the reaction chamber optionally located behind the specimen, and opposite to the at least partially transparent surface, through which the reflectance-scattering of the specimen, such as blood for example, is measured or otherwise detected. The optical background may also optionally include “the back-wall” of the container. If the back-wall itself is at least partially transparent, then the surface behind the back-wall comprises the optical background. Optical backgrounds are optionally employed to increase the contrast in light reflection-scattering between coagulated and non-coagulated blood. Regardless of placement, the optical background is capable of increasing this contrast.

According to a preferred embodiment of the present invention for implementation with blood as a specimen, it was found that a blood layer thickness of preferably at least about 0.01 mm, more preferably at least about 0.1 mm and most preferably about 0.2 mm, and a black optical background, provides a satisfactory contrast, although other optional combinations of thickness and optical background colors may optionally be employed.

Unexpectedly, it has been found that a black or dark optical background affords improved reflectance-based coagulation detection, as such a finding is taught away by the background art. Thus, U.S. Pat. No. 5,986,754 claims a highly reflective background, in the shape of a Fresnel reflector, for facilitating the detection of changes in the sample's optical properties. U.S. Pat. Nos. 6,189,370, 5,789,664, 5710622 and 5,522,255 claim alight background for determining a characteristic of a biological fluid. In reflectance photometry of blood coagulation, coagulated blood reflects more light than non-coagulated blood.

According to other preferred embodiments of the present invention, red light appears to be better suited for reflectance-scattering detection of coagulation in undiluted blood than blue, green or white light, as red light yields a better contrast between coagulated and non-coagulated blood. The contrast is also optionally improved when the angle of irradiation is smaller (i.e. the incident light angle is closer to perpendicular).

The test-strip may optionally be manufactured from flat films, with or without glue on their surface, which are preferably die-cut or stamped to the appropriate dimensions and assembled by a variety of techniques well known in the art of converting. Alternatively the entire strip or its parts can be fabricated by injection molding. In case of parts molding, assembly can be accomplished by various methods, including but not limited to ultrasonic or heat bonding. In yet another variation, chambers can be formed in otherwise flat pieces of polymer material by stamping. The test-strip may optionally be manufactured from various materials, including but not limited to, plastic resins, glass, metal, paper and their derivatives.

As previously described, the effect of the coagulation test-strip on light is preferably detected and/or otherwise measured by the complementary meter, as featured in another embodiment of the invention. The meter preferably includes a light emission source and a light sensitive component (light detector). The function of a light sensitive component is to convert the amount of light which falls on its sensitive surface into another physical entity or a form of information about the magnitude of light. The meter may also optionally include one or more processing circuits which convert the light measure into information, as well as an optional but preferred display to display the information about coagulation of the specimen in question. The meter may optionally be powered by a battery to make it portable. The light source may optionally be any sort of a lamp (incandescent, neon, etc) or solid state light emitting device/chip, like a LED (Light Emitting Diode), LASER chip, an electroluminescent device or others. LED is preferable in view of its low cost, low power, durability, size and range of available emission colors.

The light sensitive component may optionally be any of widely available devices such as photodiodes, phototransistors, photocells, Darlington phototransistors, photomultipliers and other amplified or non-amplified light detecting devices. A Darlington phototransistor consists of two separate transistors coupled in the high-impedance Darlington configuration with a phototransistor as the input transistor. It is one of many kinds of light sensors which include an amplification circuit. The light sensitive component of the present invention may optionally include any type of device for sensing light, including those devices which feature an amplification circuit and those devices which do not.

Photodiode is one of the preferred devices in view of its wide availability, low cost, small size and durability. The sensitivity of photodiodes is sufficient for the purposes of the present invention.

Photodiodes respond to light in a change of their electrical resistance. Circuit designers usually convert the photodiode resistance into voltage for the purpose of further processing. The conversion may optionally be accomplished by additional circuit components of the meter. Alternatively, amplified photodiodes, which include the photodiode with an integrated amplification circuit, can be employed. Such a device emits a voltage signal in a magnitude proportional to the amount of light falling on the device. The meter preferably includes a processing circuit(s), such as a microprocessor, which collects the signals received from the light detection circuit(s) and derives the coagulation time, based on a timing circuit for example. The meter can also optionally feature a display section, showing the results and providing instructions to the user. Other output devices which may optionally be added to a meter include but are not limited to, one or more of a printer, printer interface, telephone connection, for transmitting the results for the patient's physician, for example, and a computer interface. Collectively the combination of the meter, the container and one or more external devices may optionally form the system according to the present invention. The meter may optionally have a calendar and/or clock and a memory for storing the results and correlating them with testing dates.

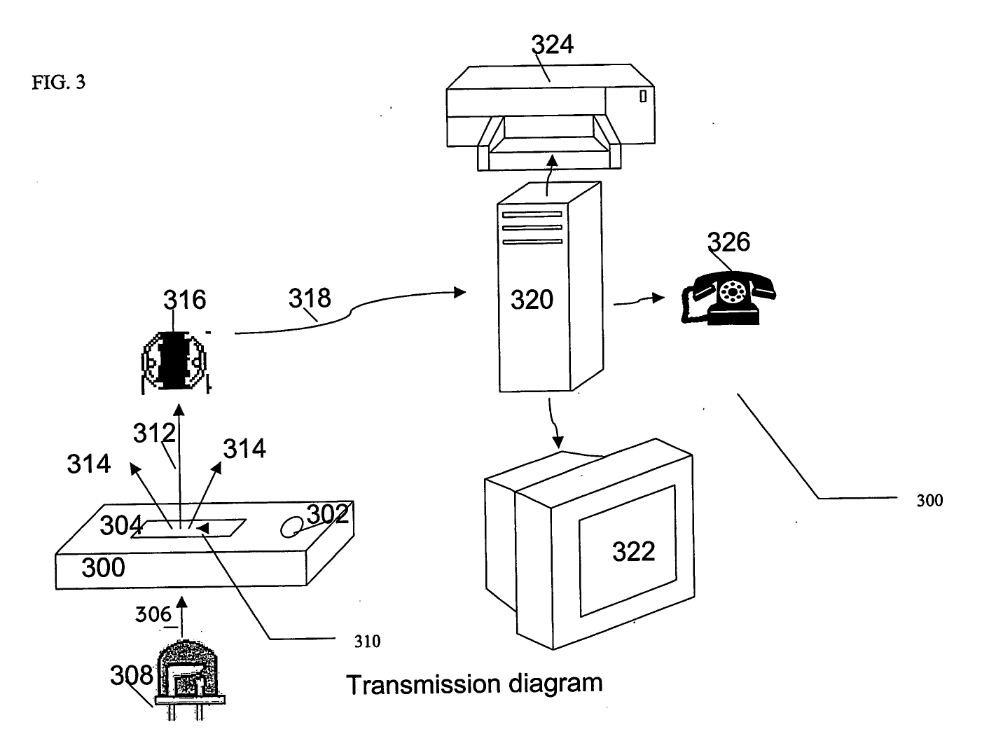

The meter optionally and preferably has a receptacle for receiving and/or otherwise communicating with the container, such as a coagulation test-strip for example, so that the at least partially transparent wall(s) of the reaction chamber are in the optical path with the light emission and detection devices of the meter. In the case of transmission photometry those devices are preferably located at opposite sides of the strip (see FIG. 3 for related block diagram), so that the emitted light traverses the reaction chamber and emerges from the other side of the strip in order to be sensed by the light sensing component (e.g. a photodiode).

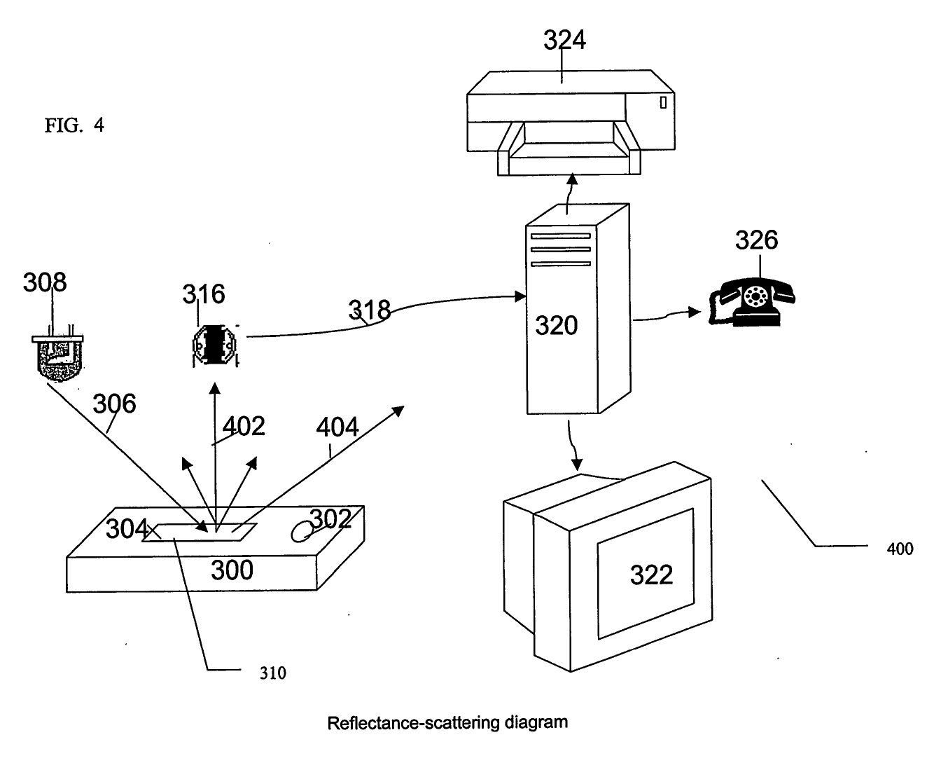

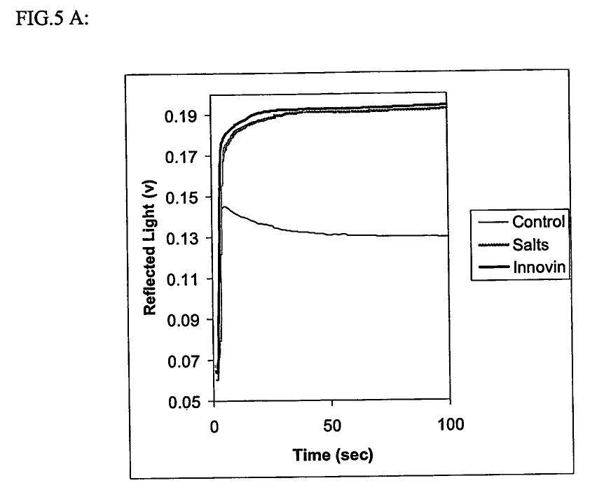

In case of reflectance-scattering photometry, both light emission and detection devices are preferably located at the same side of the test-strip and face the same area (see FIG. 4 for block diagram). Usually, optical designers prefer to locate the light source at a non-perpendicular angle relative to the tested surface and to locate the light detection device perpendicularly to the surface, as shown in FIG. 4. However, it is possible to have both devices at an angle, which is different than 90°. In such a case, the effect of light reflection from the outer surface of the test strip is preferably minimized, for example by locating the devices at different angles and/or by placing a polarizing filter in front of the light detector. Reflected light is polarized and can be absorbed by a properly aligned polarizing filter; scattered light is not polarized and is not completely absorbed by a polarizing filter.

The meter may optionally include additional optically-active devices/components with an attempt to minimize effects of ambient light and unwanted reflections and to maximize sensitivity and selectivity to the light modifying effects of the coagulating blood. Such devices include but are not limited to: filters (e.g. color, polarizing, interference), lenses, masks, apertures, shields, shutters and seals. In addition and optionally the meter can include a temperature sensor, so as to measure the ambient temperature and provide temperature compensation to the results, or to prevent the use of the system in extreme temperatures. In yet another embodiment the meter optionally and preferably includes a heating structure which maintains the test-strip at 37° C., the temperature of the standard coagulation time test procedure. It is believed that such tests can be also conducted at ambient room temperature without adversely affecting the results, as shown, for example, in PCT Application No. WO 99/47907.

According to an optional but preferred embodiment of the present invention, in order to minimize the possibility of the specimen, such as the patient's blood, contaminating the meter due to the proximity of the test-strip's inlet to the surface of the meter, preferably the test-strip length is increased, and a conduit for the specimen is provided between the inlet and the reaction chamber. The potential drawbacks of a longer conduit may include one or more of increased specimen volume, slower response and a greater chance for failure due to insufficient specimen volume. These potential drawbacks may optionally be ameliorated or even eliminated by of the following embodiments in the construction of the test-strip and the meter.

In one optional but preferred embodiment the light emission and light detection devices of the meter are preferably optically connected to the appropriate locations on the test-strip by light-guides. Light guides may optionally be made from optical fibers or designed as integral part of the test-strip's body, if it is fabricated from optically clear material. Thus, any rod shaped piece, optionally of various cross-sectional shapes (preferably, round) and made of clear material, having a suitable diffraction index relative to air, may optionally serve as a light-guide. The efficiency of light transport through a guide may optionally be further improved by cladding, which is a cover for the surface of the guide formed from a light reflective layer, such as a metal layer for example. Such arrangement allows an increase of the length of the test-strip to be made without increasing the length of blood conduits.

In an alternative optional but preferred embodiment of the test-strip structure, the light emitting and light sensitive devices are optionally and preferably incorporated, associated with and/or embedded in the test-strip itself. The devices are optionally and preferably embedded in the strip in their “naked chip” form, so that the structure of the test strip provides their cover. Solid state devices, such as photodiodes, diodes, LEDS and so forth, are composed of the solid state “chip” and “packaging”. The packaging is frequently much larger than the active chip within. For the purpose of the present invention, it is possible to use naked chips. Thus, optionally and preferably the LED chip and the photodiode chip may be assembled in a single packaging in the strip for the present invention, thus saving cost and reducing size.

In this embodiment, the strip connects to the meter via the electrical conductors of the light emission and light detection chips. The power supply for the light emission chip and the amplification circuit for the photodiode chip are preferably located inside the meter and are more preferably not single use. In the case of a test-strip with a single reaction chamber, the number of electrical conductors is preferably limited to three conductors, including a common ground for both chips and a separate anode for each, which is similar to glucose sensor test-strips. An additional reaction or control chamber would require just one additional conductor.

The micro-processor preferably included in the meter, as previously described, provides control and analysis functions to the whole test system, such as (a) light source control; (b) triggering of timing; (c) algorithms for determination of the coagulation time from the light measurement data.

The preferred light emission device of this invention, the LED, is affected by temperature: the amount of emitted light decreases slightly with increase in its temperature. The LED itself produces some heat in operation. Various algorithms may optionally be implemented to minimize or even eliminate the variability of light output. The simplest approach is to power the LED continuously. After a period of time, the temperature of the LED becomes stabilized and hence the light output also becomes stabilized. This period of time may optionally be in the range of seconds. The control algorithms can continuously measure the light output from the empty strip and preferably instructs the user to apply the blood specimen (or other specimen) only when the light level is constant or at least sufficiently stabilized for the measurement. An alternative approach is to power the LED intermittently (in a cyclic manner). Thereby the LED does not become heated and its light emission remains constant. In such an approach the sampling of the light reflected from or transmitted through the strip is also preferably performed intermittently. The rate of sampling is preferably sufficiently high to afford the required coagulation time resolution.

The algorithm for triggering the coagulation timing function is preferably relatively simple. According to an exemplary, optional implementation of this algorithm, after the control algorithm signals the user to apply the blood specimen (and/or after the user signals that the specimen has been applied, for example by pushing a button on the device), the algorithm (or software implementing this algorithm) preferably immediately (or at least shortly thereafter) causes or instructs the photodiode (or other light sensor) to monitor the detected light level, preferably by taking or receiving continuous measurements of the light. When blood enters, the amount of light significantly changes (increases or decreases) over at least a predetermined threshold of change, so that it is possible to detect that blood has entered the reaction chamber. Such a threshold could easily be determined heuristically for a particular device, according to one of skill in the art. Therefore, the measurement of elapsed time or timing in general should be started. In the case of reflection-scattering the entry of blood into the reaction or control chamber results in a sharp increase of the value of the measured light, such that this increase may optionally signal the beginning of the timing function. Conversely, the amount of light detected by the light detection device is expected to sharply fall upon blood entry in the case of the transmittance mode of operation. Therefore, optionally and preferably, the triggering algorithm operates to detect a change in an amount of light over a predetermined threshold.

The derivation of the coagulation time of a specimen from the individual measurements of light is a more difficult task. Different illustrative but preferred embodiments of the present invention include three main approaches: kinetic, ratio and quantitative.

Kinetic Determination of Coagulation Time

In the kinetic method the algorithm determines the status of the coagulation reaction from the rate of change in the light measurement. The advantage of the kinetic approach is that it does not require any reference or control reaction. Hence, a test-strip for the kinetic algorithm may optionally contain a single reaction chamber and therefore may require a smaller blood specimen; also this configuration may be more reliable in the filling stage.

The rate of the coagulation reaction continuously changes from the entry of blood into the reagent containing reaction chamber (see the Examples below). The rate of change in the light reflectance or transmittance is higher at the beginning and gradually decreases as time proceeds. In some cases the change in the amount of light stops, because when the coagulation reaction is complete, the amount of light should not stop changing. According to further preferred embodiments of the invention the coagulation time may optionally be determined from the rate of change in the amount of light by one of two illustrative approaches. The first approach is a variation on the standard approach, in which the coagulation time is based on actually measuring the time required for the rate of change in the light measurements to decrease to a defined, low value and/or the time required until the change in light measurement stops altogether. One advantage of this approach is its similarity to the standard coagulation time determination, as described in the Background section above. A possible drawback of the approach is the length of time required to complete the test of blood specimens exhibiting high values of coagulation times, which may be found in pathological specimens (exhibiting some pathological condition) or specimens of patients undergoing anti-coagulant therapy.

Another approach is the initial rate approach, in which the coagulation time of the specimen can be predicted by the rate of change at the beginning of the coagulation reaction. It was observed by the present inventor, as presented in the Examples below, that the rate of change in the light measurements soon after the entry of the blood specimen into the reaction chamber is inversely proportional to the coagulation time value of the specimen, as determined by a reference method. Thus, normal specimens, determined to have a short coagulation time, or, low INR (International Normalized Ratio), exhibit a high rate of change in the light measurements. The term “INR” stands for “International Normalized Ratio”, which is directly proportional to the ratio between the coagulation time of the patient and the average or expected coagulation time of the normal population, which is adjusted according to the relative potency of the reagents (for a more accurate explanation see for example: http://www.medicine.uiowa.edu/path_handbook/Appendix/Heme/INR.html). Pathological specimens, determined to have a long coagulation time or high INR, exhibit a slower rate of change in the light measurements. Likewise, specimens with intermediate coagulation values exhibit intermediate rates of change.

In another embodiment of the invention the rate of change in the light measurement can be determined by more than one method.

The classical method for the rate of change over time is the first derivative of the measurements. If the light measurement yield results in Volts, then the rate of voltage change is expressed in equation #1:
Rate=ΔV/Δt Equation #1
Where: ΔV is the difference in voltage over the Δt time period (preferably in seconds).
Thus, for the n^{th} second of the coagulation test, the equation can be presented also as:
Rateₜᵢₘₑ₌ₙ=(Vₙ₊ₓ−Vₙ)/(tₙ₊ₓ−tₙ) Equation #2

Where: X is the time interval, which can be of any value (seconds or part or multiples thereof). While a short time interval (for example one second or any other suitably short time interval) provides higher sensitivity to rapidly occurring changes and higher resolution, it may enhance the effect of noise, which may include or be derived from changes in measured values that are caused by electronic circuitry, digitization errors or ambient light. Thus a larger X value (i.e. longer intervals) results in more consistent results which are more clear and easy to interpret.

Ratio Determination of Coagulation Time

The ratio method for the rate of change (also referred to herein as the “Rate-Ratio method”), which is another optional but preferred embodiment of the present invention, has the advantage of overcoming mechanical, electronic and any other physical differences between meters and their components, between test-strips and blood specimens, which are not related to the status of the blood coagulation. Some non-limiting examples for differences:

(i) Optical path length of transmission test-strip, which results from the fabrication method. A longer path results in lower light transmission values (i.e. the voltage generated from the amplified sensing of the photodiode is lower), however, the effect of coagulation is relative, since it affects the blood across the whole length of the optical path.

(ii) Hematocrit level of the specimen, which is a value representing the fractional volume of the cells in the blood. Higher hematocrit values (i.e. higher concentration of cells) affect both light transmission (it may decrease) and light reflection-scattering (it may increase), without affecting the coagulation process itself.

In its simplest form the rate-ratio method can be illustrated by equation #3:
Ratio-Rateₜᵢₘₑ₌ₙ=(Vₙ₊ₓ/Vₙ)/(tₙ₊ₓ−tₙ) Equation #3
Where: X is the time interval.
The ratio-rate values are also prone to noise effects, which can be reduced by averaging of Volt measurements over the X time interval. Since the averaging already accounts for the time interval Equation #4 describes the averaged ratio for the n^{th} time point:
Averaged-Ratioₜᵢₘₑ₌ₙ=(Vₙ+ . . . +Vₙ₊ₓ)/(Vₙ₊ₓ₊₁+ . . . +Vₙ₊₂ₓ) Equation #4
The numerator and denominator in equation #4 can, of course, be interchanged without affecting the meaning of the averaged ratio. The parameters n and X can assume any value, however, it should be realized that for n=1 second and X=10 seconds the averaged ratio is derived from 20 seconds of light measurement. Therefore, and as is shown by the test results in the Examples below, an individual averaged ratio value of an early time point after introduction of the specimen may optionally be sufficient to differentiate between different coagulation time levels.

The present invention also optionally and preferably a simple ratio method for rapid determination of coagulation time. This method stems from the observation, presented in the Examples and also known from the background art, that the coagulation process commences rapidly, i.e. soon after the blood is mixed with the coagulation reagents (see for example Yonemura, M. and Motoi, S, “Outline of the Reaction Features of Prothrombin Time (PT) Reagents”, Sysmex Journal International 7(2): 50-54, 1997). According to this method, the initial light measurement(s), taken after triggering (see above about the triggering algorithm), serve as the reference value against which all further measurements are compared and their simple ratio values to that reference are calculated. This “ratio to start” value changes rapidly after triggering and assumes a value, which is proportional to the coagulation time of the specimen. In the reflectance-scattering mode of the invention the “ratio to start” value increases; in the transmittance mode the value decreases. The ratio method relies on the bandwidth of the light measurement system, i.e. the frequency of light measurements. In the reflectance-scattering mode of the invention it appears that the minimally acceptable frequency is preferably at least about 1 reading per second. In the transmittance mode a higher frequency is preferably implemented. For this optional embodiment of the present invention, the time interval for measurement of the amount of light (and/or rate of change, or ratio or any other characteristic of the behavior of the light) is preferably shorter than the coagulation time of the sample being examined.

Quantitative Determination of Coagulation Time

Quantitative determination of coagulation time relies on the value/magnitude of the light measurement rather then the kinetics of its change. For example, optionally the coagulation state is detected according to a time period required for the amount of measured light or for the rate of change in the amount of measured light, to reach a predetermined value. Since the value of light measurements is affected by various physical factors, which are not related to the coagulation reaction itself, such as hematocrit, optical path variations, variability between meters and others, a proper reference value is preferably used for corrections. The reference value may optionally be derived from two potential sources.

One source includes a control reaction chamber, which does not contain coagulation reagents. Assuming that all other physical factors are equal for the reaction and control chamber, then the difference between the light measurements of these chambers represents the sole effect of the coagulation process.

The other source for a reference value is the initial light measurement of the entering blood. Assuming that at this time point the coagulation reaction did not start yet, that measurement can serve as the reference control. Since it has been suggested that the coagulation reaction has a very rapid onset as described above, the sampling rate or bandwidth of the light measurement circuit is preferably sufficiently high and/or the coagulation reagents are preferably formulated as to reduce the rate of their dissolution and/or their potency.

The derivation of the coagulation time for a blood specimen from a corrected quantitative light measurement can be as simple as choosing a suitable time point after the introduction of the specimen and translating that value into coagulation time based on an equation correlating corrected light measurements with coagulation time. Such an equation can be derived from a series of experiments in which a large number of blood specimens are tested at the same time by a reference coagulation time method and by the method of the invention.

Another embodiment of the invention is a test kit for the determination of coagulation time of blood from a patient. The kits includes at least a meter and test-strip(s) and can include also a lancing device, lancet(s), instructions for use, control(s), a strip for testing the meter itself (such as a colored piece of plastic, for example), calibrator strip, batteries, spare batteries, tissues and any other items which may assist the patient or healthcare professional in obtaining and analyzing the blood specimen. Test-strips and packs thereof are also preferably provided as replacement kits and can include also a copy of the instructions, a calibrator, controls and other items. Controls, meter test-strips, lancing devices and lancets may also be available for users of the kit. The kit may optionally be designed for use by non-medically trained personnel, a patient, a person in a home or field environment (the latter could optionally include military situations and/or operations in the field, for example, as well as outdoor environments for hikers, campers, hunters, sportspeople and the like).

In another embodiment of the invention the method of the invention may optionally be employed for the detection/determination of agglutination in blood specimens.

According to another embodiment of the present invention, there is provided a photometric method for the determination of agglutination in whole, undiluted blood.

Optionally and preferably, the device according to the present invention is operable at ambient (“room”) temperature. More preferably, the device has a temperature measurement component. Such a component may be useful for particular embodiments, for example if the light emission source is temperature sensitive (as described above).

This method may optionally be performed with any embodiment of the device according to the present invention.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings described in the Examples section. The invention is capable of other embodiments or of being practiced or carried out in various ways. Also, it is to be understood that the phraseology and terminology employed herein is for the purpose of description and should not be regarded as limiting.

Referring now to the drawings, FIG. 1 shows a schematic block diagram of different exemplary shapes for a chamber in a test strip 100 according to the present invention, shown in a lateral cross-section. A first shape is a keyhole shape 102 shown with a test strip 100 labeled “A”, a second shape is a “U” shape 104 shown with a test strip 100 labeled “B”, and a third shape is a rectangular shape 106 shown with a test strip 100 labeled “C”. Of course different shapes could also optionally be used for the chamber.

FIG. 2 shows a container featuring a plurality of chambers. The plurality of chambers may optionally be arranged in parallel or sequential order. A first container 200 preferably features a plurality of chambers 202 in sequential order, while a second container 204 preferably features a plurality of chambers 206 in parallel order. Arrows indicate the direction of entry to the respective chambers 202 and 206. When chambers 206 are arranged in parallel, the blood sample preferably enters a common inlet conduit 208, which is then preferably split into a manifold 210 leading into multiple parallel cavities.

In a sequential arrangement, the blood first enters a chamber 212, which preferably does not contain coagulation reagents. The blood continues to fill also the next chamber 214, which preferably does contain one or more coagulation reagents. The theoretical advantage of the sequential arrangement is a potentially higher degree of reliability and/or reproducibility by ensuring the the specimen fills all chambers 202.

FIG. 3 shows an exemplary device and system according to the present invention for transmission of light through the specimen or sample. A test strip 300 has an inlet 302 and reaction chamber 304, preferably with at least partially transparent walls. Incident light 306 is radiated from a Light Emitting Diode 308, traverses a specimen 310 in the reaction chamber 304, and emerges as vertically transmitted 312 and scattered-transmitted 314 light components.

Transmitted light 312 impinges on a light sensor 316, which preferably transmits an electric signal 318 to a processing system 320. Processing system 320 converts the signal to data, analyzes it and calculates the coagulation time of the specimen. Processing system 320 preferably includes one or more of the previously described algorithms for determining when the signal should be measured and/or for calculating the coagulation time. The result can optionally be displayed by a display 322, printed by a printer 324 or transmitted by a transmitter 326 to a remote device or location, for example.

FIG. 4 shows another exemplary device and system 400 according to the present invention for reflectance-scattering. Unlike for FIG. 3, incident light 306 is radiated from a Light Emitting Diode 308, but now is reflected 404 and scattered 402 from specimen 310 in reaction chamber 304. The scattered light 402 impinges on a light sensor 316. The remainder of system 400 operates as for the example in FIG. 3, except that different algorithms are preferably used as previously described.

Any of the above components in FIGS. 3 and 4 may optionally be selected from components that are known in the art.

Some aspects of the invention will be illustrated by the following non-limiting examples.

### EXAMPLE 1

### Preparation of Test-Strips

Thromboplastin Reagent: Dried Innovin® Reagent with calcium (Dade Behring, Inc.; Deerfield, Ill.) was resuspended in water according to the manufacturer's instructions and stored at 4-8° C. for up to 1 week.

Innovin salts solution, which is functionally equivalent to the contents of the original Innovin solution (buffer, calcium and protein), but which does not include thromboplastin or lipids, was prepared according to U.S. Pat. No. 5,625,036 and included:

1.4415 gr HEPES

0.16 gr CaCl₂.2H₂O

0.5844 NaCl

5.0 gr glycine

0.135 gr Bovine Serum Albumin (Bovuminar® Biotechnology Premium Grade pH 7, Serologicals Corp, Norcross, Ga.)

Reagent Grade Water to 100 mL

pH adjusted to 7.0

(The Bovine Serum Albumin is not a component of the original Innovin® reagent. It is added to the salts solution to simulate the protein load in that original reagent)

The base of the test-strips was constructed from a flat optically clear Lexan® film, 250 or 500 micron thick on which an adhesive covered 240 micron thick polyester film (Ritrama, USA) structure was attached. The adhesive structure thus defined a rectangular trough with dimensions of 20×4 mm or 20×3 mm. The trough area was treated with a ˜1 sec corona discharge from a hand-held laboratory treater unit (Electro-Technic Products, Chicago, Ill., USA) and immediately thereafter a 16 mm length of the trough was coated with either Innovin or Innovin salts solution. The 3×20 mm trough was coated with 16.0 μL solution and the 4×20 mm trough—with 21.5 μL. Following a 1 hour drying at 45° C., the reagent covered area of the troughs was covered with a corona treated 250 micron clear Lexant® film.

The prepared strips were stored at ambient room temperature.

### EXAMPLE 2

### Determination of Preferred Color of Light and LED Output for Reflectance-Scattering

A reflectance measurement test was built according to the block diagram in FIG. 4, employing red green and white LEDs (LiteON, Taipei, Taiwan) as the light source and a Texas Instruments TSL250 light-to-voltage sensor (Texas Instruments, USA) as the light measurement device. The sensor's lens was covered with a mask having a 1 mm pinhole. The background (see definitions) behind the test-strip was a matt-black vinyl film (Ritrama, USA). The voltage output of the sensor was recorded by an Extech 380281 digital multi-meter (Extech Instruments Corp., Waltham, Mass., USA) connected to a computer, running Extech's DMM data acquisition software. The angle of light incidence was 32.5° or 60°.

Innovin containing strips and empty strips (i.e control strips) were filled with whole, citrate preserved, fresh capillary blood. Following 5 minutes incubation at room temperature the reflected light values from the control and Innovin strips were compared (Table 1). The light incidence angle in this test was 32.5°.

TABLE 1
Effect of LED Color on Coagulation Detection by Reflectance

| LED | Control Strip | Innovin ® Strip | Ratio |
|---|---|---|---|
| Color | (Volts) | (Volts) | (Innovin/Control) |
| Red | 0.052 | 0.115 | 2.21 |
| Green | 0.090 | 0.150 | 1.67 |
| White | 0.009 | 0.011 | 1.22 |

It is clear that red light provides the highest contrast between coagulated and noncoagulated blood. This observation was further supported by color scanning of those test strips and analyzing the RGB (Red Green Blue) components of the image (which is, essentially, a recording of the reflected-scattered light from the strip). When the angle of light incidence was increased to 600 there was no significant effect on the contrast with red light.

In another experiment (different date and blood specimen) the effects of LED output and of the amount of Innovin were tested. Innovin coated test-strips were prepared as described in Example 1. They were compared with test-strips which were coated with double the volume of Innovin. Results are presented in Table 2.

TABLE 2
Effect of LED output and Innovin Concentration
on Coagulation Detection by Reflectance

| | |
|---|---|
| Innovin | Innovin/Control Ratio with LED output of |

| Concentration | 120 mCD | 500 mCD |
|---|---|---|
| ×1 | 1.52 | 1.87 |
| ×2 | 1.62 | 2.05 |

There is an increase of about 25% in contrast when using a higher output LED. Doubling the concentration of Innovin afforded less than about 10% improvement in the ratio.

### EXAMPLE 3

### Effect of Thromboplastin Coagulation Reagent on Reflectance-Scattering of Light

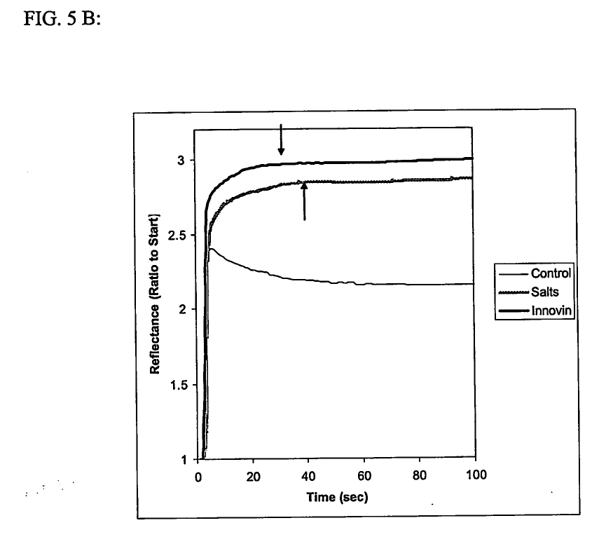

The temporal reflectance-scattering of light from test-strips containing Innovin (i.e reagent with thromboplastin and calcium), or Innovin salts (i.e. reagent with calcium but without thromboplastin) and control strips (i.e. no reagent) was recorded following the introduction of an 18 μL citrate preserved, fresh capillary blood specimen. The raw light measurements are depicted in FIG. 5A. The calculated ratios of each measurement to the starting measurement (taken at blood entry) are depicted in FIG. 5B. The reaction chamber of the control strip used to produce FIGS. 5A and 5B did not contain any reagent. The salts strip contains salts and proteins but no thromboplastin. The Innovin strip contains dried Innovin. FIG. 5A presents the temporal light measurements. FIG. 5B presents ratios of the light measurement in each time point to the starting light measurement for each of the different types of test-strips.

The effect of a calcium containing reagent on the reflectance of blood is very clear from FIG. 5A. Without any reagent the amount of reflected-scattered light gradually decreases, while the presence of a reagent causes the amount of reflected-scattered light to increase. The ratios in FIG. 5B accentuate the effect of a thromboplastin containing regent over the effect of a reagent without it. Both reagents contain calcium, which is sufficient to induce coagulation of the citrate preserved capillary blood (capillary blood also contains relatively high amounts of thromboplastin-like components due to its harvesting method). However, due to its high content of thromboplastin, Innovin should induce a faster and larger coagulation response. This is clear from FIG. 5B inasmuch as the Innovin test-strip induced a higher level of reflectance than the salts test-strip. In addition, the reflected light in the Innovin strip leveled off earlier than that in the salts strip (see arrows in FIG. 5B).

### EXAMPLE 4

### Effect of Coagulation Reagents and Color of LED on the Transmission of Light

A transmission measurement test device was built according to the block diagram in FIG. 3, employing Red (LiteON), blue or green LEDs (Nichia (Tokyo, Japan) as the light source and a Texas Instruments TSL250 light-to-voltage sensor (Texas Instruments, USA) as the light measurement device. The sensor's lens was covered with a mask having a 1 mm pinhole. The voltage output of the sensor was recorded by an Extech 380281 digital multi-meter (Extech Instruments Corp., Waltham, Mass., USA) connected to a computer, running Extech's DMM data acquisition software for analyzing the voltage measurements from the sensor.

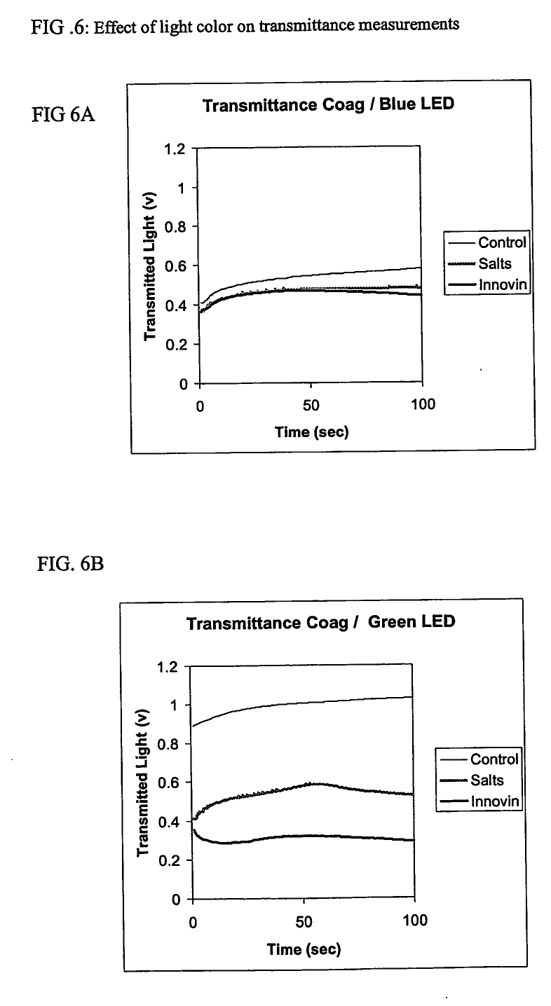

The temporal transmission of light from test-strips containing Innovin (i.e reagent with thromboplastin and calcium), or Innovin salts (i.e. reagent with calcium but without thromboplastin) and control strips (i.e. no reagent) was recorded following the introduction of an 18 μL citrate preserved, fresh capillary blood specimen. The raw light measurements with a blue light source are depicted in FIG. 6A. The measurements with a green light source are depicted FIG. 6B. The light sensor could not detect any light when a red light source was employed.

For the experiments whose results are shown in FIGS. 6A and 6B, the reaction chamber of the control strip does not contain any reagent. The salts strip contains salts and proteins but no thromboplastin. The Innovin strip contains dried Innovin. The top panel presents the temporal light measurements with blue light. The bottom panel presents the temporal light measurements with green light.

According to the data presented in FIG. 6, (a) no specific response to thromboplastin or salts could be detected with a blue light source, and (b) when a green light source was employed, there was a clear difference between the test-strips. Only Innovin could induce a decline in the transmittance of the blood, while thromboplastin-free salts could not.

### EXAMPLE 5

### Prothrombin Time (PT) and Light Transmittance

Normal, intermediate and high PT whole blood specimens were prepared from commercially available Dade-Bebring coagulation control plasmas, selected to have different coagulation times, and fresh type 0 erythrocytes as follows: Three aliquots of two hundred μL of fresh, citrate-preserved type 0 capillary blood were centrifuged at 3000 rpm for 5 minutes. One hundred μL of the clear plasma supernatant was removed from each of the aliquots to be replaced with a one hundred μL aliquots of each of the control plasmas. The erythrocytes were resuspended and then centrifuged again. Another 100 μL of the clear plasma supernatant were removed to be replaced by another 100 μL aliquot of the same control plasma. Following resuspension of the erythrocytes, those reconstituted specimens were tested for their approximate coagulation time by the tube-tilting visual method with a fresh, liquid Innovin reagent, to validate that those specimens exhibit different coagulation times. The approximate coagulation time values were 16, 34 and 44 seconds for the normal, intermediate and high specimens respectively.

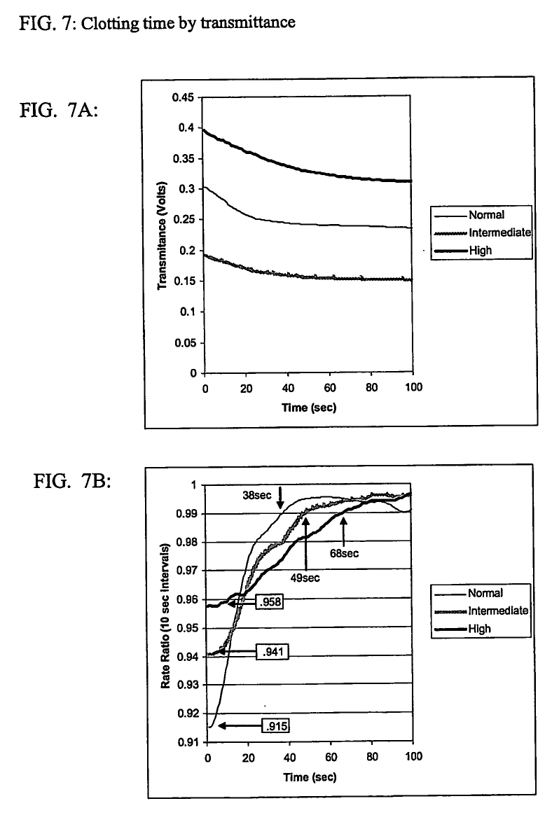

The specimens were applied to Innovin containing test-strips (see Example 1 for preparation details) in a light transmittance test device (prepared according to Example 4) equipped with a green LED. The raw light measurements are depicted in FIG. 7A. The 10 second calculated rate-ratios (see Detailed Description of the Preferred Embodiments section for explanation on the Rate-Ratio calculation) of each measurement are depicted in FIG. 7B.

The top chart (FIG. 7A) displays the temporal transmitted light measurements of three whole blood specimens, which were applied to Innovin containing test-strips. The specimens exhibit normal, intermediate and high PT values, as determined by reference PT test. The bottom chart (FIG. 7B) displays the temporal values of the Rate Ratios.

The raw data in FIG. 7A shows that all specimens caused a decrease of light transmission through them, in accordance with the results in Example 4. However, there are no outstanding differences in the shapes of the voltage transients, except for a difference in the over all levels, which are not in accordance with the expected coagulation level. Such apparently random differences may be caused by variations in the hematocrit and plasma turbidity among specimens and/or by variation in the optical path of the test-strips. However, applying the 10 second rate-ratio calculation to the light measurement (FIG. 7B) brings out the coagulation dependent variation between the specimens. This variation is already detectable in at the beginning of the reaction (time 0 on the chart, the value of which is derived from the initial 20 seconds of the test and which is the time of blood entry), where the initial rate-ratios for the normal, intermediate and high specimens were 0.915, 0.941 and 0.958 respectively. Later in the reaction, the differences are demonstrable in the time points when the rate ratio values reach a 0.990 value at 38, 49 and 68 seconds. Other rate-ratio values could be chosen with the same effect.

### EXAMPLE 6

### Prothrombin Time (PT) and Light Reflectance-Scattering

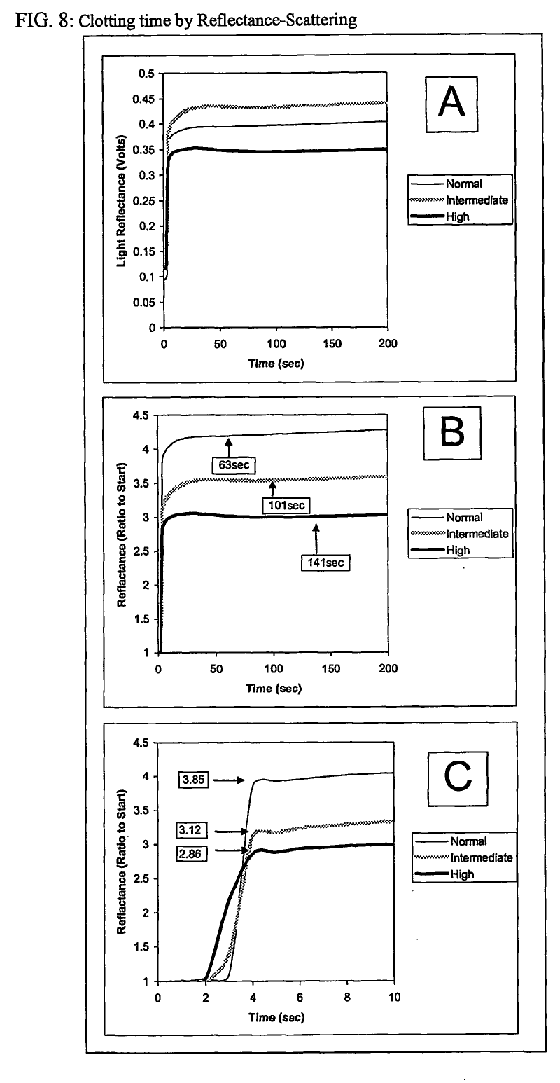

Whole blood specimens were prepared essentially as described in Example 5. They were applied to Innovin containing test-strips (see Example 1 for preparation details) in a red LED equipped Reflectance Scattering test device, described in Example 2. The raw light measurements are depicted in FIG. 8A. The calculated Ratios to Start (see Detailed Description of the Preferred Embodiments section for explanation) of each measurement are depicted in FIGS. 8B and 8C.

The graph in FIG. 8A displays the temporal reflected light measurements of three whole blood specimens, which were applied to Innovin containing test-strips. The specimens exhibit normal, intermediate and high PT values, as determined by the reference PT test. The graph in FIG. 8B displays the temporal values of the “Ratios to Start”. The graph in FIG. 8C displays the first 10 seconds of the reaction in FIG. 8B, demonstrating that the “Ratios to Start” predict the differences in coagulation time in 4 seconds after blood entry into the test-strips.

All the specimens caused an increase in the reflectance-scattering, as expected from the results of Example 3. As in Example 5, there were no outstanding differences in the shapes of the voltage transients, except for a difference in the over all levels, which were not in accordance with the expected coagulation level. Those random looking differences may have been caused by variations in the hematocrit and plasma turbidity among specimens and/or by variation in the dimensions of the test-strips.

The coagulation related differences, however, are clearly depicted in FIGS. 8B and C, which show the temporal behavior of the “Ratio to Start” values for each light measurement (see Detailed Description of the Preferred Embodiments section for explanation of the Ratio to Start calculation). First, the overall value of rate ratio is inversely proportional to the expected PT values of the specimens. This is expected since longer coagulation time is a result of reduced coagulation capability. A measure of the PT can either be determined from the arrows FIG. 8B pointing to the 63, 101 and 141 seconds time points, where the reflectance of the normal, intermediate and high specimens start to increase after a period of decline. FIG. 8C shows that the coagulation level of the specimens can be assessed as soon as 4 seconds after the start of the reaction, employing the initial maxima of the “Ratio to Start” values. Those ratios are 3.86 for the normal PT specimen (highest coagulation rate), 3.12 for the intermediate and 2.86 for the high PT (slowest coagulation rate).

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, patent applications and sequences identified by their accession numbers mentioned in this specification are herein incorporated in their entirety by reference into the specification, to the same extent as if each individual publication, patent, patent application or sequence identified by their accession number was specifically and individually indicated to be incorporated herein by reference. In addition, citation or identification of any reference in this application shall not be construed as an admission that such reference is available as prior art to the present invention.

1. A device for the photometric determination of coagulation in a sample of undiluted whole blood, comprising:
(a) a container for receiving the sample of undiluted whole blood;
(b) a light emission source for emitting light, such that said light is projected onto said container; and
(c) a light detector for measuring an amount of light from said container, such that said amount of light is affected by a coagulation state of the undiluted whole blood,
wherein the coagulation is determined according to said amount of light.

2. The device of claim 1, wherein said container comprises a reaction chamber for receiving the sample of undiluted whole blood, and wherein a depth of the sample of undiluted whole blood in said reaction chamber is less than about 10 mm.

3. The device of claim 2, wherein said depth is less than about 1 mm.

4. The device of claim 3, wherein said depth is less than about 0.1 mm.

5. The device of claim 1, wherein said light detector measures at least one of reflectance-scattering of light from the sample transmission of light through the sample, transmittance-scattering of light through the sample, or absorption of light by the sample.

6. The device of claim 5, wherein said light detector measures at least one of transmission of light through the sample, transmittance-scattering of light through the sample, or absorption of light by the sample, and wherein at least one wall of said reaction chamber is at least partially transparent, such that said light detector is located on an opposing side of said at least one wall from the sample.

7. The device of claim 2, wherein the sample of blood enters said reaction chamber according to a force.

8. The device of claim 7, wherein said force includes at least one of capillary, gravitational, vacuum, pressure, electric, endosmotic, osmotic, hydrophobic, hydrophilic or centrifugal force, or a combination thereof.

9. The device of claim 8, wherein said force comprises at least one of gravitation and capillary force.

10. The device of claim 1, further comprising a housing, wherein said light emission source and said light detector are contained within said housing, and said container is inserted into said housing.

11. The device of claim 1, further comprising a housing and at least one light guide, wherein said light emission source and said light detector are contained within said housing, and at least a first portion of said at least one light guide is contained within said housing, while at least a second portion of said at least one light guide protrudes from said housing, such that light from said light emission source is transmitted to said container through said at least one light guide, while light from said container is brought to said light detector through said at least one light guide.

12. The device of claim 1, further comprising a housing and at least one light guide, wherein said light emission source and said light detector are contained within said housing, and at least a first portion of said at least one light guide is contained within said housing, while at least a second portion of said at least one light guide is located within said container, such that light from said light emission source is transmitted to said container through said at least one light guide, while light from said container is brought to said light detector through said at least one light guide.

13. The device of claim 1, wherein said light detector and said light emission source are mounted on said container.

14. The device of claim 1, wherein said coagulation state is determined according to a rate of coagulation of the sample.

15. The device of claim 14, wherein said rate of coagulation is determined according to at least one of deflection points, ratios and rate ratios.

16. The device of claim 1, wherein said coagulation state is detected according to a time period for said amount of light to reach a predetermined value or said rate of coagulation to reach a predetermined value.

17. The device of claim 1, wherein said coagulation state is detected according to a ratio of change of a plurality of light measurements taken after said container receives the sample of undiluted whole blood, said ratio of change being proportional to the coagulation time of the sample.

18. The device of claim 17, wherein said container comprises a reaction chamber and wherein said ratio of change is determined at least partially according to an initial light measurement when the blood enters said reaction chamber.

19. The device of claim 17, wherein said ratio of change is determined at least partially according to an initial light measurement determined according to a triggering algorithm.

20. The device of claim 19, wherein said triggering algorithm operates to detect a change in an amount of light over a predetermined threshold.

21. The device of claim 20, wherein said change is determined after blood is applied to the container.

22. The device of claim 1, wherein said coagulation state is detected according to a quantitative determination of coagulation time.

23. The device of claim 22, wherein said quantitative determination is performed according to at least one of a value or a magnitude of an amount of light.

24. The device of claim 22, wherein said quantitative determination is relative to a reference value.

25. The device of claim 24, wherein said reference value comprises at least one of a control reaction chamber for receiving a portion of the sample or an initial light measurement with the sample substantially before a coagulation process is initiated.

26. The device of claim 1, wherein said light emission source comprises at least one of a lamp or a solid state light emitting device/chip.

27. The device of claim 26, wherein said solid state light emitting device/chip is selected from the group consisting of a LED (Light Emitting Diode), LASER and an electroluminescent device.

28. The device of claim 1, wherein said light detector includes at least one of a photodiode, phototransistor, photocell, Darlington phototransistors, or a photomultiplier.

29. The device of claim 28, wherein said light detector comprises a photodiode.

30. The device of claim 1, wherein the device is operable for determining coagulation at an ambient temperature.

31. The device of claim 1, further comprising a temperature measurement component.

32. The device of claim 1, wherein said container comprises a test strip.

33. The device of claim 1, wherein at least agglutination is measured.

34. The device of claim 1, further comprising a dark optical background.

35. A kit comprising the components of the device of claim 1.

36. The kit of claim 35, wherein said kit is designed for use by any one or more of non medically trained personnel, a patient, a non-professional or lay person, or any person in a home or field environment.

37. The kit of claim 35, wherein said kit is portable.

38. A method for photometrically measuring coagulation in a sample of undiluted whole blood, comprising:
providing a device for measuring coagulation of the sample, wherein said device comprises a test strip having a reaction chamber for receiving the sample for said measuring, wherein a light path with regard to the sample in said reaction chamber is less than about 10 mm;
performing at least one of transmitting light through and reflecting light from the sample; and
measuring at least one of coagulation rate and coagulation time of the sample according to at least one of transmitted or reflected light.

39. The method of claim 38, wherein coagulation rate is measured for determining coagulation time in the sample, wherein a period of time for measuring said coagulation rate is less than about said coagulation time.

40. The method of claim 38, wherein at least agglutination is measured.

41. The method of claim 38, wherein said device comprises a device according to claim 1.

42-44. (canceled)

45. A method for the determination of coagulation time of a blood sample, comprising determining the coagulation time of a blood sample within a time interval shorter than the coagulation time of said sample.

46. A system for photometrically measuring coagulation in a sample of undiluted whole blood, comprising:
(a) a device according to claim 1; and
(b) at least one output device for providing a result from a measurement by said device to a user.

47. The system of claim 46, wherein said output device is selected from the group consisting of a printing device, a display device and a transmission device for transmission to a remote location.
